(19) United States
(12) Patent Application Publication
(10) Pub. No.: US 2009/0202853 A1
(43) Pub. Date: Aug. 13, 2009

(54) Stretched polymers, products containing stretched polymers, and their methods of manufacture

(76) Inventor: John N. Magno, Middletown, NJ (US)

Correspondence Address: FOLEY AND LARDNER LLP;SUITE 500, 3000 K STREET NW, WASHINGTON, DC, 20007, US

(21) Appl. No.: 12/289,768

(22) Filed: Nov. 3, 2008

Related U.S. Application Data
(63) Continuation-in-part of application No. 12/149,539, filed on May 2, 2008.
(60) Provisional application No. 60/916,066, filed on May 4, 2007.
(60) Provisional application No. 60/960,250, filed on Sep. 21, 2007.

(51) Int. Cl. B32B 27/32; D01D 5/12; C08F 110/00; C08F 110/02

(52) U.S. Cl. 428/523; 264/210.8; 526/348; 526/352

(57) ABSTRACT

Certain stretched polymers have defects which reduce their tenacity and effectively render the stretched polymers opaque. These defects are at least in part cause by the undesirable stresses being applied to the fiber. Such stresses may be avoided by avoiding by avoiding bending and twisting during processing. Such stretched polymers may be used in optically clear application such as bullet resistant glass. Additionally, such stretched polymers may have other advantageous properties.

### RELATED APPLICATIONS

This application is a continuation-in-part of U.S. patent application Ser. No. 12/149,539, filed May 2, 2008, which claims priority from U.S. Provisional application Ser. No. 60/916,066, filed May 4, 2007, and U.S. Provisional application Ser. No. 60/960,250, filed Sep. 21, 2007, all three applications are incorporated in their entireties herein by this reference.

### FIELD OF THE INVENTION

The present invention relates generally to stretched polyolefin fibers and their method of manufacture, and more particularly, to ultra-high molecular weight stretched polyolefin fibers having new and/or improved properties and their method of manufacture.

### BACKGROUND

Theoretical analysis indicates stretched polyolefin fibers such as polyethylene fibers should have tenacities much higher than what has been observed. Yet despite a great deal of research and a clear commercial need for such fibers, the tenacity of polyolefin fibers remains low. Accordingly, there is a strong need in the art to improve the tenacity of fibers.

### SUMMARY OF THE INVENTION

An aspect of the present invention is to provide a highly oriented polyolefin fiber including a polyolefin fiber with a tensile strength of at least 60 g/denier and a modulus of tension of at least 1400 g/denier. The tenacity may be higher than 60 g/denier. For example, the tenacity may be at least 65 g/denier, at least 70 g/denier, at least 75 g/denier, at least 80 g/denier, at least 85 g/denier, at least 90 g/denier, is at least 100 g/denier, or even at least 110 g/denier. The modulus of tension may be higher than at least 1400 g/denier. For example, the modulus may be at least 1600 g/denier, at least 1700 g/denier, at least 1800 g/denier, at least 1900 g/denier, at least 2000 g/denier, at least 2100 g/denier, or even at least 2200 g/denier. Furthermore, the fiber may have an energy-to-break of at least about 75 joules/gram. The energy-to-break may be higher than at least about 75 joules/gram. For example, the energy-to-break may be at least about 90 joules/gram, at least about 120 joules/gram, at least about 150 joules/gram, or even at least about 200 joules/gram. The polyolefin fiber may be a polyethylene fiber. The polyolefin fiber may be embedded in a polymer to for an anti-ballistic article. Such an article may be opaque or transparent.

Another aspect of the present invention is to provide a highly oriented polyolefin fiber including a polyolefin fiber with a tensile strength of at least 60 g/denier and a having a non-axial stress induced defect density of less than 2000 per meter of stretched polymer. The defect density may be substantially smaller than 2000 per meter of stretched polymer. For example, the defect density may be less than 1000 per meter of stretched polymer, less than 400 per meter of stretched polymer, or even less than 100 per meter of stretched polymer. The tensile strength of the polyolefin fiber may be at least 65 g/denier or even higher. For example, the tensile strength may be at least 70 g/denier or even at least 75 g/denier. The fiber may have a modulus of tension of the polyolefin fiber is at least 1400 g/denier. The fiber may have an energy-to-break of at least about 65 joules/gram or even higher. For example, the energy-to-break may be at least about 75 joules/gram, at least about 90 joules/gram, or even at least about 120 joules/gram. The polyolefin fiber may be a polyethylene fiber. The polyolefin fiber may be embedded in a polymer to for an anti-ballistic article. Such an article may be opaque or transparent.

Another aspect of the present invention is to provide a polymer filament including a stretched polymer having a tenacity greater than 82 g/denier.

Another aspect of the present invention is to provide a method of making a drawn polyolefin fiber including gel-spinning gel-fiber from a polyolefin material and another material, removing a substantial amount of the another material from the gel-fiber to form a xerogel and elongating the xerogel at an elevated temperature, to form a drawn fiber. The removing a substantial amount of the another material from the gel-fiber is at least partially performed such that only axial or substantially axial stresses are applied to the gel-fiber. The removing a substantial amount of the another material from the gel-fiber may have an earlier portion and a later portion where the later portion has less non-axial stresses than the earlier portion. The elongating the xerogel may be at least partially performed such that only axial or substantially axial stresses are applied to the xerogel. The elongating the xerogel may have an earlier portion and a later portion where the earlier portion has less non-axial stresses than the later portion.

Another aspect of the present invention is to provide a method of making a drawn polyolefin fiber including gel-spinning gel-fiber from a polyolefin material and another material, removing a substantial amount of the another material from the gel-fiber to form a xerogel and elongating the xerogel at an elevated temperature, to form a drawn fiber. The elongating the xerogel is at least partially performed such that only axial or substantially axial stresses are applied to the xerogel. The elongating the xerogel may have an earlier portion and a later portion where the earlier portion has less non-axial stresses than the later portion.

Another aspect of the present invention is to provide a substantially transparent article including oriented polyolefin fibers comprising a plurality of polyolefin fibers with a tensile strength of at least 10 g/denier embedded in a transparent polymer. The transparent polymer is index matched to the plurality of polyolefin fibers and each polyolefin fiber of the plurality of polyolefin fibers has a non-axial stress induced defect density of less than 2000 per meter. The tenacity may be higher than 10 g/denier. For example, the tenacity may be at least 20 g/denier, at least 30 g/denier, at least 40 g/denier, at least 50 g/denier, at least 60 g/denier, at least 65 g/denier, at least 70 g/denier, at least 75 g/denier, at least 80 g/denier, at least 85 g/denier, at least 90 g/denier, is at least 100 g/denier, or even at least 110 g/denier. Additionally, the non-axial stress induced defect density may be substantially less than 2000 per meter in each polyolefin fiber. For example, the non-axial stress induced defect density may less than 1000 per meter in each polyolefin fiber, less than 400 per meter in each polyolefin fiber, or even less than 100 per meter in each polyolefin fiber. The transparent polymer may be index matched to within 0.05 of the plurality of polyolefin fibers. The polyolefin fibers may be polyethylene fibers.

### BRIEF DESCRIPTION OF THE DRAWINGS

The invention will be described in detail with reference to the following drawings in which like reference numerals refer to like elements wherein:

FIG. 1 is an illustration of a conventional photograph of a conventional stretched UHMWPE fiber observed under a Niemarski microscope in the dark field mode with under magnification;

FIG. 2 is another illustration of a photograph of a conventional stretched UHMWPE fiber observed under a Niemarski microscope in the dark field mode with under magnifications without any index matching fluid;

FIG. 3 is an illustration of a photograph of a prior-art UHMWPE fiber immersed an index matching fluid and viewed under magnification with a polarizing microscope;

FIG. 4 is an illustration of a photograph of a prior-art UHMWPE fiber placed under tension, immersed an index matching fluid and viewed under magnification with a polarizing microscope;

FIG. 5 is an illustration of a photograph of prior art fiber and a fiber prepared according to example 1;

FIG. 6 illustrates a fiber fabrication machine 600 that may be used for producing fiber;

FIG. 7 illustrates a fiber fabrication machine 700 that may be used for producing fiber;

FIG. 8 illustrates a section of good quality fiber under magnification that has had the mineral oil removed but has not been stretched;

FIG. 9 illustrates the section of good quality fiber under magnification of FIG. 8 after bending it around a small radius curve with little or no tension;

FIG. 10 illustrates an unstretched fiber section having defects under magnification;

FIG. 11 illustrates a stretched fiber section having defects under magnification; and

FIG. 12 illustrates a cross section of a pre-preg product.

### DETAILED DESCRIPTION

The production of polyolefin fibers such as stretched polyethylene fibers fail to achieve higher tenacities because current production techniques introduce defects that weaken the fibers. These defects may be described as cracks, fractures, crystal dislocations or some other manifestation of a problem. However, the nature and mechanism that affects the properties of the fiber is not yet fully understood. What is understood is that these defects result from non-axial stresses (e.g., bending or twisting) during the production process and that the presence of these defects reduces the tenacity of the resultant fibers. The non-axial stresses are any stresses not along the long of axis of the polymer. In other words, non-axial stresses are any stresses on the fiber that are not used to stretch the fiber.

A polyolefin polymeric material and a solvent material (e.g., Kaydol white mineral or a paraffin oil or a combination of materials) are mixed and gel spun from a spinneret as a gel-fiber. The gel-fiber then has the solvent materials substantially or wholly removed to form a xerogel. As the gel-fiber transitions to the xerogel it becomes more and more susceptible to the introduction of defects from non-axial stresses. As the xerogel is stretched, this susceptibility to defect introduction is reduced. In a conventional manufacturing process, non-axial stresses are applied as the solvent material is removed and/or as the fiber is stretched. For example, the gel-fiber/xerogel and/or the xerogel/stretched xerogel are wound around small radii that cause bending non-axial stresses that in turn cause defects. By processing linearly (e.g., not bending or twisting) and/or substantially linearly (e.g. by using larger radii bends), the introduction of defects may be substantially reduced or eliminated such that the tenacity of the resultant fibers is improved.

In addition to the improvement of the tenacity, processing linearly or substantially linearly, may improve other properties of polyolefin fibers. For example, the reduction or absence of defects reduces or eliminates scattering centers such that the fiber may be used in optically clear or transparent applications. Similarly, the reduction or absence of defects results in a modulus, percent strain at break or yield, and/or energy to break of the fiber that may be improved as compared to conventional fibers.

These non-axial stress induced defects become visible upon illumination under a polarizing microscope such as Niemarski polarizing microscope in the dark field mode under magnification once the fibers have been immersed in index matching fluid with a refractive index between 1.45 and 1.52 for a few minutes. Some of these defects are clearly occurring generally periodically along the fiber and have a generally similar appearance while the remaining defects seem to occur at random intervals and have an appearance that differs from each other and that differs from the defects are clearly occurring periodically. It may also be possible to observe these defects by other means.

The failure to identify and/or appreciate the importance and/or engineer a solution for these defects likely result from a number of factors. First, standard scanning electron microscopes needs a conductive layer be deposited on the fiber before analysis because the fiber is a poor conductor. This may have masked the presence of the defects such as the defects that appear under tension. Second, conventional stretched ultra high molecular weight polyethylene (UHMWPE) fiber was believed to be opaque. This belief may have resulted from a number of things such as the somewhat rough surface of conventional stretched UHMWPE fibers, the defects acting as scattering centers, processing in oxygen which may have increased the absorption of light in the fiber, processing with over heated mineral oil that could increased the absorption of light in the fiber, and the delay before index matching fluids provide a viewable result. Third, there are a large number of factors which affect the tenacity of a fiber. The factors may have diverted researches efforts away from the real reason for the low tenacity of the fibers.

Fiber produced using with linear processing or substantially linear process advantageously has a tensile strength of at least 60 g/denier, and with a tensile strength of at least 65 g/denier being more advantageous, and with a tensile strength of at least 70 g/denier being even more advantageous, and with a tensile strength of at least 75 g/denier being even more advantageous, and with a tensile strength of at least 80 g/denier being even more advantageous, and with a tensile strength of at least 85 g/denier being even more advantageous, and with a tensile strength of at least 90 g/denier being even more advantageous, and with a tensile strength of at least 100 g/denier being even more advantageous, and with a tensile strength of at least 110 g/denier being even more advantageous. Such fiber also has other advantageous properties such as a high modulus. For example, the fiber produced using with linear processing or substantially linear process advantageously has a modulus of tension of at least 1400 g/denier, and with a modulus at least 1500 g/denier being even more advantageous, and with a modulus at least 1600 g/denier being even more advantageous, and with a modulus at least 1700 g/denier being even more advantageous, and with a modulus at least 1800 g/denier being even more advantageous, and with a modulus at least 1900 g/denier being even more advantageous, and with a modulus at least 2000 g/denier being even more advantageous, and with a modulus at least 2100 g/denier being even more advantageous, and with a modulus at least 2200 g/denier being even more advantageous. Another advantageous property is the energy-to-break. The fiber produced using with linear processing or substantially linear process advantageously has an energy-to-break at least about 75 joules/gram, and with an energy-to-break at least about 90 joules/gram being even more advantageous, and with an energy-to-break at least about 120 joules/gram being even more advantageous, and with an energy-to-break at least about 150 joules/gram being even more advantageous, and with an energy-to-break at least about 175 joules/gram being even more advantageous, and with an energy-to-break at least about 200 joules/gram being even more advantageous, and with an energy-to-break at least about 250 joules/gram being even more advantageous, and with an energy-to-break at least about 300 joules/gram being even more advantageous, and with an energy-to-break at least about 350 joules/gram being even more advantageous and with an energy-to-break at least about 400 joules/gram being even more advantageous.

The fiber may be embedded into a polymer to form an anti-ballistic article and that article may be opaque to visible light or it may substantially transmit visible light. The fiber may have a non-axial stress induced defect density of less than 2000 per meter of stretched polymer, with a non-axial stress induced defect density of less than 1000 per meter of stretched polymer being more advantageous, and a non-axial stress induced defect density of less than 400 per meter of stretched polymer being even more advantageous, and a non-axial stress induced defect density of less than 100 per meter of stretched polymer being even more advantageous.

The fiber produced using a linear processing or substantially linear process advantageously may be selected to have one or more of the properties (e.g., tenacity, modulus, energy-to-break, and defect density) with values as listed in the above two paragraphs. One or more of the properties may also be less than the values as listed in the above two paragraphs. Fibers having said values in each of the various combinations may be produced and may have certain advantages in certain applications.

Fiber manufactured with a linear processing or substantially linear process typically utilizes polymeric material with a molecular weight from about 1 to about 10 million. However, other weights outside of this range may also be used.

A substantially transparent article including oriented polyolefin fibers embedded in a transparent polymer can be manufactured when the oriented polyolefin fibers used therein are made by a linear processing or substantially linear process. In order to improve the optical clarity of the substantially transparent article, it may be desirable to use oriented polyolefin fibers that are partially drawn. Such fibers would have a lower tensile strength. For example, such a fiber may only have a tensile strength of at least 10 g/denier or it may have a higher tensile strength. For example, the tenacity may be at least 20 g/denier, at least 30 g/denier, at least 40 g/denier, at least 50 g/denier, at least 60 g/denier, at least 65 g/denier, at least 70 g/denier, at least 75 g/denier, at least 80 g/denier, at least 85 g/denier, at least 90 g/denier, is at least 100 g/denier, or even at least 110 g/denier. The transparent polymer is index matched to the plurality of polyolefin fibers and each polyolefin fiber of the plurality of polyolefin fibers has a non-axial stress induced defect density of less than 2000 per meter. Additionally, the non-axial stress induced defect density may be substantially less than 2000 per meter in each polyolefin fiber. For example, the non-axial stress induced defect density may less than 1000 per meter in each polyolefin fiber, less than 400 per meter in each polyolefin fiber, or even less than 100 per meter in each polyolefin fiber. The transparent polymer may be index matched to within 0.05 of the plurality of polyolefin fibers. The polyolefin fibers may be polyethylene fibers.

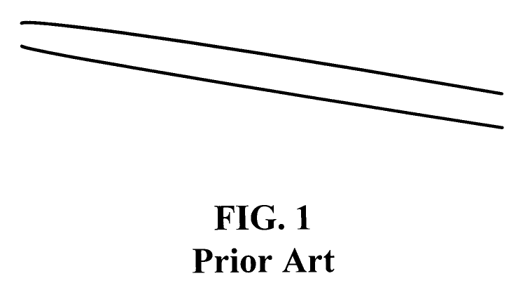

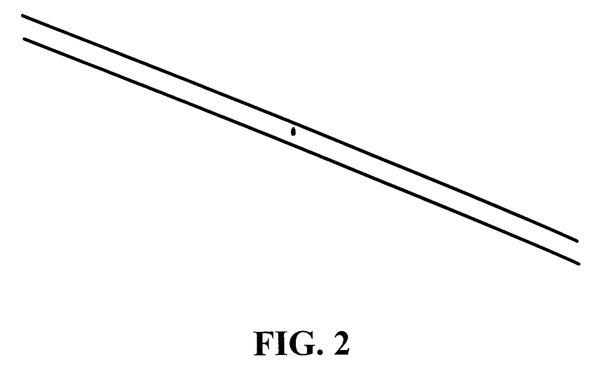

FIG. 1 is an illustration of a conventional photograph of a conventional stretched UHMWPE fiber observed under a Niemarski microscope in the dark field mode with under magnification. The conventional stretched UHMWPE fiber appears to be structurally sound. Similarly, FIG. 2 is another illustration of a photograph of a conventional stretched UHMWPE fiber observed under a Niemarski microscope in the dark field mode with under magnifications without any index matching fluid. As can be seen in FIG. 2, there are no obvious defects. Upon the addition of index matching fluid and waiting a short period of time, defects in the fiber will become obvious.

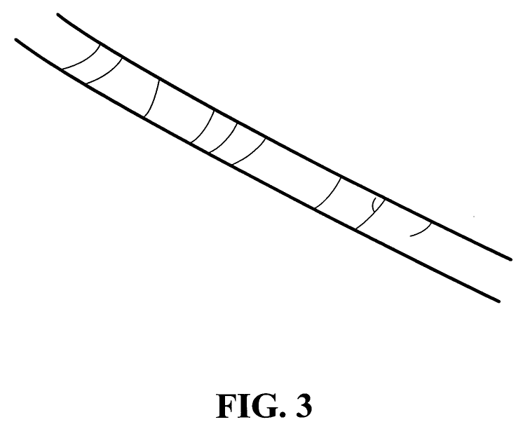

FIG. 3 is an illustration of a photograph of a prior-art UHMWPE fiber immersed an index matching fluid and viewed under magnification with a polarizing microscope. A series of defects are seen to cross the fiber at an angle roughly perpendicular to its long axis. The density of the defects in this fiber is on the order of 200 defects per millimeter. In general the defect densities of prior art UHMWPE fibers is in the range of about 200 to about 900 or more defects per millimeter. The exact density and severity of the defects appears to vary somewhat on a fiber to fiber basis.

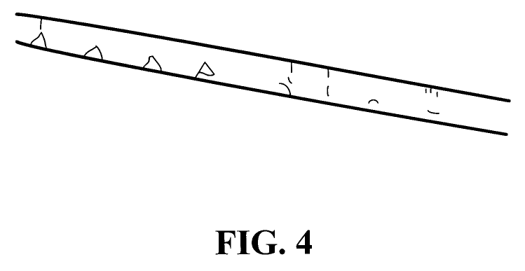

FIG. 4 is an illustration of a photograph of a prior-art UHMWPE fiber placed under tension, immersed an index matching fluid and viewed under magnification with a polarizing microscope. The tension was created by adhering cellophane tape to the two opposite ends of a segment of prior-art UHMWPE fiber and manually pulling the tape. The tension opens up the defects into wider wedge-shaped cracks. The fiber appears to be on its way to failing under this stress, which suggests that these defects to be a cause for the failure of stretched UHMWPE fibers at a level of tension that is lower than that predicted theoretically. Specifically, the defects illustrated in FIG. 4 strongly suggest that at least part of the fiber is compromised due to these defects. Since it appears that all prior-art UHMWPE fibers have such defects while nonetheless achieving only a fraction of their theoretical strength, it is believed that such defects are primarily a surface phenomenon that leaves a central core of the fiber intact. This would help explain why UHMWPE fibers have achieved only a fraction of their theoretical strength.

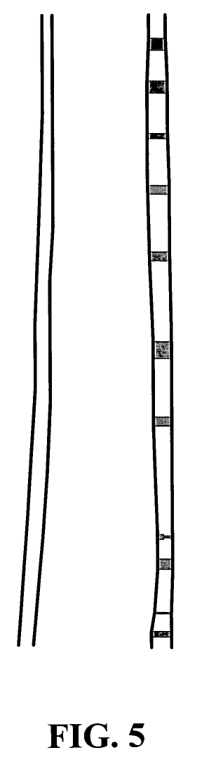

FIG. 5 is an illustration of a photograph of prior art fiber and a fiber prepared according to example 1. The prior art fiber located to the right side shows numerous dark spots which are the defects. The fiber prepared according to example 1 is on the left and does not have these dark spots.

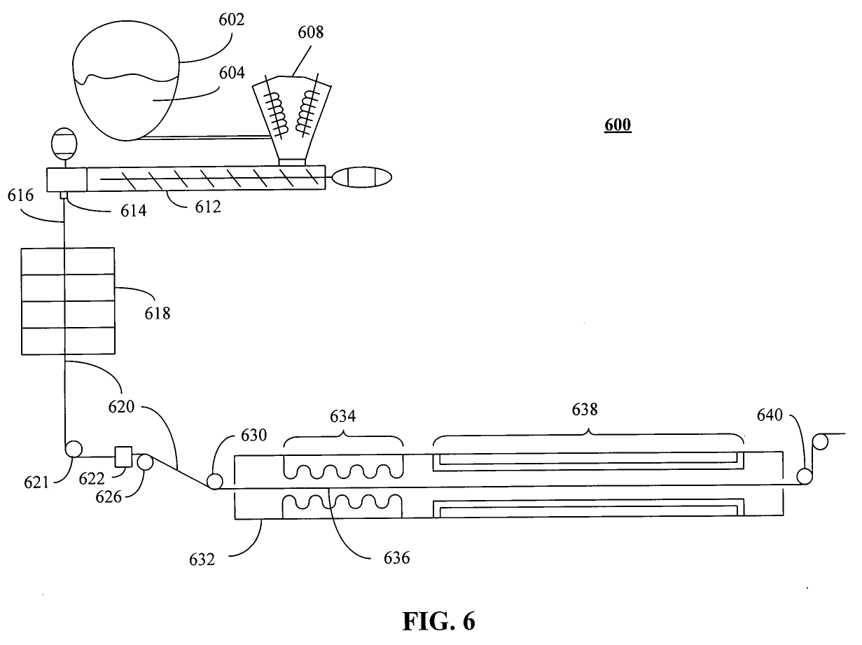

FIG. 6 illustrates a fiber fabrication machine 600 that may be used for producing fiber. The fiber fabrication machine 600 includes a premix container 602 is filled with the raw materials 604 (See Table 1 for a list of some exemplary materials) used to make the fiber. The mixed and degassed raw material 604 may be transferred into an optional storage tank (not shown) or may be directly transferred into a helical mixer 608. The mixed and degassed raw material 604 that is transferred into the helical mixer 608 is heated to above the gelation temperature of the UHMWPE powder. Some or all of the heating may occur during the transfer to the helical mixer 608 or all of the heating may occur in the helical mixer 608. The size of the helical mixer 608 is selected so as to keep a minimum the raw materials are heated to just below their liquid point so as to minimize degradation of the mineral oil. An inert gas may be added to the helical mixer 608. The inert gas prevents exposure of the raw material 604 in the helical mixer 608 to oxygen or other gases which may degrade the optical clarity of the resultant fiber. A metering pump 612 then pumps out the raw material 802 from the helical mixer 608 at the desire rate and forces it through the spinneret 614.

The spinneret 614 then extrudes one or more gel fibers 616 (the number of apertures is often between 16-240) into a cooling system 618. The cooling system 618 may be made of a plurality of baths (the baths may be all be same or may be different baths), may be a single bath having a temperature gradation, or may be a combination of both. The use of a plurality of baths allow for improved control over loading factors and all for the use of different solvents. The cooling system 618 may be a horizontal system or a vertical system. The horizontal system is advantageous in that it is closer to a conventional bath but a vertical would align gravity with the stretching direction of the one or more gel fibers 616 and might reduce the amount of mechanically induced surface features thereby making such a fiber more suitable for optically clear applications. The one or more gel fibers 616 are still able to chemically combine with oxygen or other gases which may degrade the optical clarity of the resultant fiber, so inert gas is used to fill any “air” gaps. Upon cooling down, the gel fibers 616 become stable unstretched fibers 620 that may be processed (e.g., bent, twisted, separated etc.) without creating defects. But, once the mineral oil is removed from unstretched fibers 620, the unstretched fibers 620 lose their stability and become susceptible to the creation of defects. The one or more gel fibers 616 and unstretched fibers 620 are drawn by an initial godet roller 621. Heating the godet roller 621 may reduce the number of defects.

After leaving the cooling system 618, the unstretched fibers 620 are maintained in an inert gas environment and separated from each other by a fiber separator 622. The fiber separator 622 may include a comb like structure that guides the unstretched fibers 620 onto one or more grooved drums 626. The separation of the unstretched fibers 620 helps ensure uniform stretching and orientation of molecules of the unstretched fibers 620 by a stretching system.

The separated unstretched fibers 620 are fed into stretching system. The stretching system linearly stretches the separated unstretched fibers 620 so as to minimize or eliminate the undesirable mechanical stresses that can cause defects. The first part of the stretching system is a first motorized godet roller 630. The first motorized godet roller 630 essentially takes in the separated unstretched fibers 620 with a minimal amount of tension being transferred backwards through the fiber fabrication machine 600. The first motorized godet roller 630 also secures the separated unstretched fibers 620 such that tension may be applied by a second motorized godet roller 640 which runs at a speed that is greater than the first motorized godet roller 630 to stretch the separated unstretched fibers 620.

From the first motorized godet roller 630, the separated unstretched fibers 620 are fed into a temperature controlled tube 632 that is filled with an inert gas. The temperature controlled tube 632 includes a heating portion 634 that heats the separated unstretched fibers 620 to an elevated temperature (e.g., 90-160° C., preferably 130-160° C.) into stretchable fibers 636 that will elongate and orient under the tension created by the first and second godet rollers 630, 640. The next part of the temperature controlled tube 632 is a cooling portion 638 that slowly cools the stretchable fibers 636 into high strength stretched UHMWPE fibers 642. The heating portion 634 is much shorter than the cooling portion 638. For example, the heating portion 634 may be 10 feet in length while the cooling portion 638 may be 90 feet in length. The stretching of the stretchable fibers 636 primarily occurs in the heating portion 634 of the temperature controlled tube 632. As the temperature of the stretchable fibers 636 cools, it becomes less stretchable and more prone to forming defects. The stretching system may be oriented horizontally, vertically or at some angle. Additional stretching systems may be included to improve the control over the stretching process and/or to make the overall system smaller and/or to better avoid undesirable mechanical stresses.

Alternatively, space may be saved by including rollers and the like in the fiber fabrication machine 600. Any such rollers should have large radii and be located where the temperature is elevated to minimize the formation of defects. For example, rollers with radii of at least five centimetres may be used to reduce defects as compared to rollers having smaller radii. Such defects may be further reduced by using rollers with radii of at least ten centimetres and may be still further reduced by using rollers with radii of at least twenty centimetres. Such defects may be even further reduced by using rollers with even larger radii.

Another alternative is that the cooling system 618 may use gases or spray instead of baths. Yet another alternative is to use some combination or combinations of gases, sprays and baths.

In addition to the use the invention in with respect to UHMWPE fibers, the inventive concepts disclosed herein may be used with respect to other polyolefin fibers.

The fibers produced according to the methods disclosed herein have far fewer defects than convention fibers. This allows the fibers to be used in optically clear applications such as cockpit canopies, bullet resistant windows, ultra-strong clear fishing line, ultra-strong clear coverings, clear face shields or face masks for blast protection, improved safety glass, clear hand held safety shields such as used by riot police, clear protective coverings, clear tapes, and many other applications. In military applications, clear shields could be attached to various types of carried and mounted weapon systems to reduce to stop sniper or enemy fire, or to stop shrapnel from explosions such as IEDs or rocket blasts.

The stretching ratio of the fibers may be reduced in order to improve the optical clarity of optically clear fibers. For example, the stretching ratio may be reduced from that where optical clarity is irrelevant (e.g., opaque applications) by 20 to 80%. Such reductions in the stretching ratio to increase the optical clarity must be balanced against the lost tenacity of the resultant fibers.

The refractive index of the fiber may be adjusted by the substitution of some of the hydrogen atoms on the polyethylene backbone with fluorine atoms. Such a substitution may be achieved by using a polyethylene/polyvinyl fluoride copolymer as a component of or all of the material from which the stretched filaments are produced. Alternatively, the substitution may be achieved by blending polyvinyl fluoride into the polyethylene or other polyolefin from which the stretched fibers are produced. Other copolymers may also be used.

Although various aspects of the invention are discussed in terms of fibers, it is also applicable to tapes and other geometries.

Additional elements, systems and the like that are used in conventional fiber fabrication machines may be added to the fiber fabrication machine of the present invention. For example, a drying device may be included to dry the fiber. Keeping with the principles discussed above, such a drying device might blow a heated nitrogen gas instead of heated air as is conventional.

### Example 1

A stainless steel 2.5 gallon jacketed vessel with a paddle-type stirrer was charged, in order, with a mixture of mineral oil (94.2 wt. %), a linear UHMWPE powder (5 wt. %), antioxidant powder (0.5 wt. %) and a lubricity additive (0.3 wt. %). The mineral oil used was white mineral oil. The linear UHMWPE powder was Himont UHMW 1900, the antioxidant powder was Ciba Irganox® B-225 and the lubricity additive was aluminum stearate.

This mixture was then heated at 1 deg./min. to about 150° C. with constant stirring at 10 rpm and a nitrogen blanket of 2 psi was applied to the top of the vessel for 15 hours. These parameters were maintained and created a slurry. This slurry was then left to cool to 70° C. and then transferred into a heated helical mixer preheated to 70° C.

Nitrogen was then applied to the helical mixer at 2 psi along with a motor rotation (mixing) of 5 rpm. The temperature was raised to about 155° C. at 2 deg./minute and held at about 155° C. for 30 minutes as the motor rotation was increased to 10 rpm. Next, the temperature was increased at a rate of 2° C./minute to about 180° C. and then maintained at about 180° C. for 30 minutes.

The motor rotation was then increased to 15 rpm as the nitrogen pressure was increased to 12 psi and the valve at the base of the mixer was then opened to allow flow of the slurry to the three-holed spinneret. The spinneret temperature was maintained at about 168° C. as the material flowing from the spinneret was quenched in a liquid bath of water located 6 inches below the output face of the spinneret. The spinneret hole dimensions were 0.65 mm in diameter by ¾ inch in depth.

The water bath used was a stainless steel rectangle container with dimensions of two foot wide by two foot deep by four feet long. This bath had a continuous water flow heated to a temperature of about 15° C.

The xerogel extruded uniform solution filament was then pulled down to the water and held just below the surface using 2 four-inch diameter Teflon coated rollers 3 feet apart and that spin freely and through the water at a rate of four meters a minute onto a single four-inch diameter by 6 inch long plastic spool. Once 100 meters of fiber was wound upon this single four-inch spool, the fiber was collected and the run ended.

The fiber was then immersed in xylene for 24 hours for cleaning. The fiber was then re-spooled and again immersed in xylene for another 24-hour period. This process was repeated a third time. No unnecessary tension was applied to the xerogel during the re-spooling process. Next, a heat gun set to a low temperature was used during the drying cycle by re-spooling the xerogel and using the heat gun airflow to dry the fiber, this process was repeated five times until xerogel was completely dry.

Next an 8 inch diameter by 11 inch long godet roller that was not motorized and an 8 inch by 11 inch long motorized godet roller at a 30:1 stretch ratio. Each godet roller worked in tandem with an air-assisted fiber idler roller. Between the two godet rollers was a ¾ inch, six-foot long hollow copper convection-type heating tube that housed three thermocouples. The distance from the end of the heating tube to each godet roller was 18 inches. The heating tube also had a nitrogen purge of 2 psi going into the entry point of the fiber. The fiber were wrapped multiple times around the first idler roll and the unmotorized godet roller providing a non-rotational anchor point before entering the six foot copper tube. The fiber was then wrapped multiple times around the second godet roller and idler roll to provide another fixed anchor point. The godet roller was then rotated slowly to stretch to the fiber to a ratio of 30:1. This process was repeated a second time at a fiber draw ratio of 15:1 and then a third time at 15:1 for the final process. This results in a total draw ratio of about 60:1.

The resultant fibers were tested for tenacity. They had 58 to 78 g/denier as measured by ASTM D2256-2. The fibers were placed in an index matching fluid and observed with a polarizing microscope in the dark field mode. The numerous defects observed in prior art fibers were not observed in the inventive fibers.

### Example 2

An 8CV Helicone mixer with 2 helical blades was charged with about half of the mineral oil, followed by the linear UHMWPE powder, and then the rest of the mineral oil. In total, 5930 g (94.8 wt. %) of mineral oil was used and 325 g (5.2 wt. %) of linear UHMWPE powder was used. The mineral oil used was Kaydol white mineral oil from Brenntag and the linear UHMWPE powder was GUR 4120 (linear polyolefin resin in powder form with a molecular weight of ca. 5.0 mM g.mol that includes calcium sterate in a concentration of 500 parts per million or 0.05% wt. % of the GUR 4120) from Ticona. The mixture is stirred at room temperature for approximately one hour.

The mixture was then heated to about 188° C. with constant stirring in the reverse direction (to facilitate upward migration of bubbles) under a full vacuum. This continued until the mixture bubbles disappeared such that the mixture was completely degassed. Once the bubbles disappeared and the mixture appeared clear, the temperature of the mixture was lowered to approximately 130° C. and a blanket of argon at 1-3 psi was applied.

Once the mixture reached approximately 130° C., the mixing speed was reduced to the slowest setting and the mixing direction was changed to the forward direction, creating a downward flow to facilitate pump feeding. The valve at the base of the mixer was then opened to allow flow of the mixture to the metering pump. The metering pump and all components in the column were maintained at approximately 130° C. except for the spinneret die which was maintained at a temperature of approximately 135° C. to approximately 140° C. There was a single 0.05 mm diameter hole in the spinneret die.

The hole in the spinneret die was submerged in a water bath. The water bath was heated to approximately 93° C. adjacent the spinneret die and cooled with ice on the opposite end creating a thermal gradient over the 14 foot bath.

The mixture was pumped through the spinneret die so as to form a gel filament. The gel filament was then pulled through the water, held just below the surface, and taken up on a 3 inch diameter core. The gel filament was rewound with no overlapping filaments and developed in a Soxlet extractor using hexane as a solvent for three complete cycles that took about a half hour each. After the third cycle, the developed fiber was air dried.

Lastly, sample pieces of developed fiber were drawn by attaching a weight to one end and suspending in a 6 foot long tube containing distilled water, uniformly heated to 82° C. (180° F.).

### Example 3

Fiber was produced substantially as in Example 2 except the hole in the spinneret die was left exposed to air and the gel filament was wound around plastic cores and a lower molecular weight materials was used. Specifically, the material used were 5460 g (94.0 wt. %) of mineral oil was used and 350 g (6.0 wt. %) of linear UHMWPE powder was used. The mineral oil used was Kaydol white mineral oil from Brenntag and the linear UHMWPE powder was GUR 4012 (linear polyolefin resin in powder form with a molecular weight of ca. 1.0 mM g.mol that includes a small amount of calcium sterate) from Ticona. The gel filaments were removed from the core and place on a holder to keep the gel filaments straight during oil extraction in a Soxlet. The development in the Soxlet extractor was performed by using hexane as a solvent for three complete cycles that took about a half hour each. After the third cycle, the developed fiber was air dried. Care was taken to avoid stressing the fiber. Specifically, care was taken to avoid bending or twisting the developed fiber. The developed fiber was then stretched by hand using heated air. Care was taken to avoid bending or twisting the fiber. The stretched fiber was bundled and weighed, and then tested on an Instrong® tensile testing machine. A first test resulted in a tenacity of 110 gram per denier and a second test resulted in a tenacity of 133 grams per denier.

### Example 3

### Introduction of Defects

Some developed fiber from Example 3 was optically examined and no defects were observed. The fiber was divided into three parts. The first part of the fiber was pulled around a small radius (a few millimeters) under no tension and at room temperature. The fiber was again optically examined and lots of defects were observed. The second part of the fiber was pulled around a small radius (a few millimeters) under light tension and at room temperature. The fiber was again optically examined and lots of defects were observed. The third part of the fiber was twisted under no tension and at room temperature. The fiber was again optically examined and lots of defects were observed. Each of the three fibers was then stretched in the same manner as was the rest of Example 3. The introduced defects changed during stretching but remained observable. The resultant stretched fibers with the defects were not as uniform as the rest of the fiber produced in Example 3 and appeared to have a lower tenacity.

### Example 4

Additional fiber was produced substantially the same as in example 3. The fiber was tested using a TexTechno VibroMat ME denier testing machine to determine the denier according to ASTM D1577. The properties where then determined according to ASTM D3822-7 on a Q-Test/5 tensile testing machine. The grip pressure was 70 psi, and the lab conditions were 70° F. and 65 RH. The initial and cross head speeds were both 15 mm/min. and the brk sensitivity was 75%. The results are summarized below.

| Property | Sample 1 | Sample 2 | Sample 3 |
|---|---|---|---|
| Denier (in denier) | 4.640 | 7.740 | 5.780 |
| Peak Load (in grams) | 500.59 | 590.53 | 482.56 |
| Break Load (in grams) | 500.59 | 590.53 | 482.56 |
| Yield Load (in grams) | 500.59 | 590.53 | 482.56 |
| Fiber Modulus (in grams/denier) | 2102.76 | 1910.95 | 2562.19 |
| Tenacity (in grams/denier) | 107.89 | 76.30 | 83.49 |
| Nominal gauge length (in mm) | 25.400 | 25.400 | 25.400 |
| Slack (in mm) | 0.083 | 0.052 | 0.102 |
| Corrected gauge length (Nominal | 25.483 | 25.452 | 25.502 |
| gauge length plus slack) (in mm) | | | |
| Energy-to-break (joules/gram) | 400 | 296 | 210 |

Although the fibers produced in Examples 3 and 4 include hand processing, it is preferable to produce the fibers solely with mechanical solvent extraction and drawing machines that do not or substantially do not cause non-axially stresses when defects are likely to be induced by such stresses.

TABLE 1
Exemplary Raw Materials 604

| | |
|---|---|
| Mineral oil | Witco's Kaydol ® white |
| | mineral oil |
| UHMWPE powder (1-11 | Himont UHMW 1900, Ticona GUR 4012, |
| million molecular weight | Ticona GUR 4120, Ticona GUR 4150, |
| linear polyethylenes) | Ticona GUR 4170 |
| Antioxidants | Ciba Irganox ® B-225 |
| Lubricity additives | Aluminum stearate, calcium sterate |
| Solvents | Tetrafluoroethane, CTFE - Genesolv, |
| | Genetron 134a, or HFC-134a, xylene, |
| | hexane |
| Inert gas | Nitrogen, Argon |

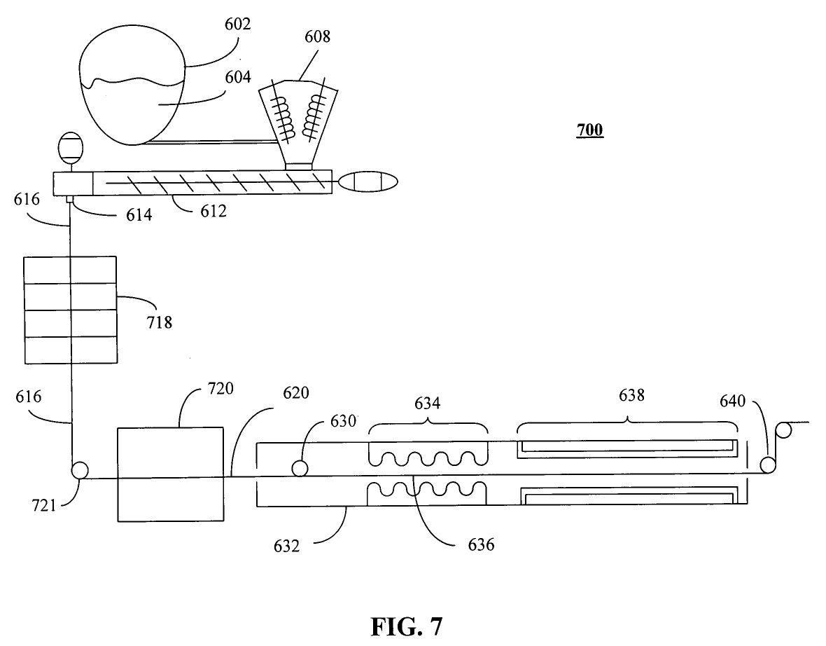

FIG. 7 illustrates a fiber fabrication machine 700 that may be used for producing fiber. The fiber fabrication machine 700 is similar to the fiber fabrication machine 600 of FIG. 6 except that the one or more gel fibers 616 are aligned along an axis prior to the removal of the mineral oil such that the undesirable defects are further reduced. The one or more gel fibers 616 are drawn through a graduated quenching bath 718 by an initial godet roller 721. Subsequent to the graduated quenching bath 718 and the initial godet roller 721 is an oil removal bath 720. The functions of cooling system 618 of FIG. 6 are separated provided by the graduated quenching bath 718 and the oil removal bath 721. The initial godet roller 721 should be located before the oil removal bath 720 because stresses on the one or more gel fibers 616 result in either no defects or far fewer defects in response to non-axial stresses. Additionally, the placement of the initial godet roller 721 before the oil removal bath 720 obviates the advantage of heating the initial godet roller 721 to further reduce the generation of defects since the one or more gel fibers 616 are generally not susceptible to the generation of defects from non-axial stresses. In order to avoid transmitting tension to the unstretched fibers 620 between the initial godet roller 721 and the first godet roller 630 in the temperature controlled tube 632, the unstretched fibers 620 may be wrapped multiple times around the first godet roller 630. The diameter of the first godet roller 630 should be made as large as practical to minimize or eliminate non-axial stresses that would otherwise generate defects.

The fiber fabrication machine 700 of FIG. 7 also differs from the fiber fabrication machine 600 of FIG. 6 in that the fiber separator 622 and the one or more grooved drums 626 are omitted as they may be more likely to increase the number of defects rather than reduce them.

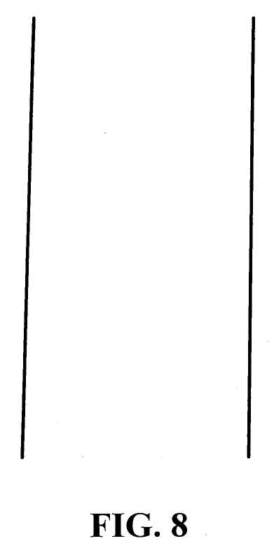

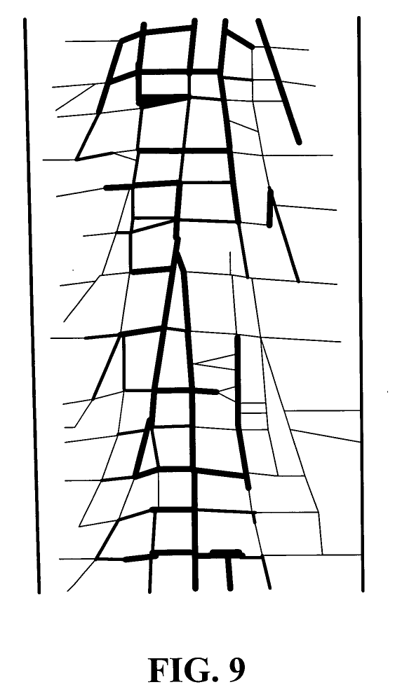

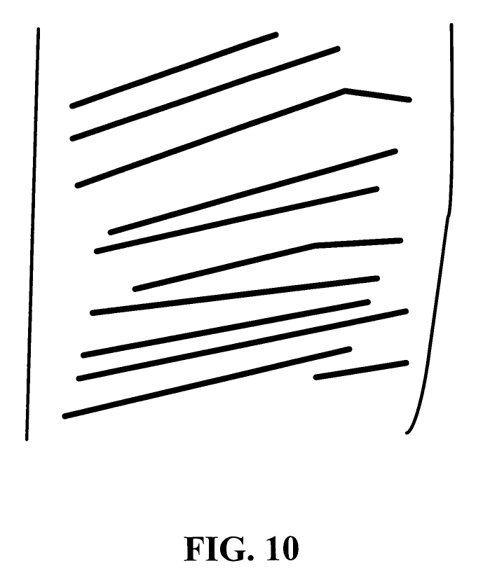

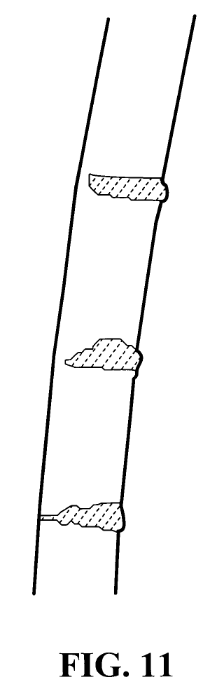

The cause or causes of fiber defects are not well understood. But it is clear that that good quality fiber when processed such that non-linear forces such as those that occur while going around a curve results in defects. For example, FIG. 8 illustrates a section of good quality fiber under magnification that has had the mineral oil removed but has not been stretched. Notice the absence of dark areas which are defects. Taking the good quality fiber of FIG. 8 and simply bending it around a small radius curve with little or no tension produces lots of defects (the dark areas) as is illustrated in FIG. 9. FIG. 10 illustrates another piece of unstretched fiber section having defects. Defective unstretched fiber such as in FIG. 10 becomes defective stretched fiber such as illustrated in FIG. 11.

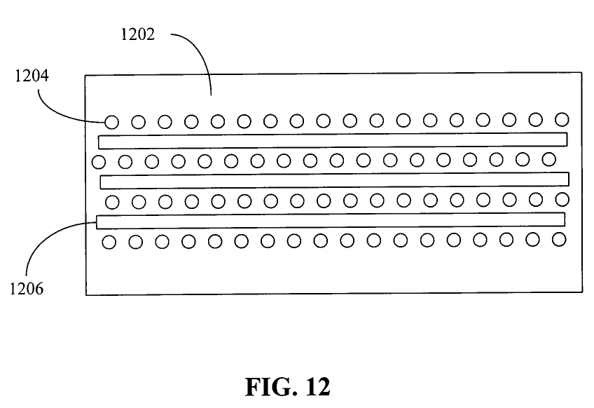

FIG. 12 illustrates a cross section of a pre-preg product. The pre-preg product includes a polymer matrix 1202 (or any other suitable material) and layers of fibers. Some of the fibers 1204 are aligned normal to the plane of the cross section while other fibers 1206 are aligned parallel to the plane of the cross section. For an optically clear or transmissive pre-preg product, the polymer matrix is index matched to the fibers 1204, 1206. Transmissive pre-preg products may be used as bullet resistant glass, safety glass, face masks, transparent shields, protective shields for gun emplacements or guard stations, and the like. Thin layers of a transmissive pre-preg product may be used to retro-fit glass windows or the like.

An advantage of linear or substantially linear processing, other than the improved tenacity and other properties, is high tenacity and high denier fibers may be produced because the higher stresses induced in larger fibers that result in more and/or worse defects is not present in linearly or substantially linearly processed fibers. Such thick fibers could be used in many applications. For example, a thick fiber should be able to carry an optical signal a short distance. By using an optical signal in body armor or other armor, failure of the armor could be detected. This could be used to indicate a man down in body armor or simply the need to replace a piece of spall lining in a vehicle.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A highly oriented polyolefin fiber comprising at least one polyolefin fiber with a tensile strength of at least 60 g/denier and a modulus of tension of at least 1400 g/denier.

2. The highly oriented polyolefin fiber according to claim 1, wherein the tensile strength of the at least one polyolefin fiber is at least 65 g/denier.

3. The highly oriented polyolefin fiber according to claim 1, wherein the tensile strength of the at least one polyolefin fiber is at least 70 g/denier.

4. The highly oriented polyolefin fiber according to claim 1, wherein the tensile strength of the at least one polyolefin fiber is at least 75 g/denier.

5. The highly oriented polyolefin fiber according to claim 1, wherein the tensile strength of the at least one polyolefin fiber is at least 80 g/denier.

6. The highly oriented polyolefin fiber according to claim 1, wherein the tensile strength of the at least one polyolefin fiber is at least 85 g/denier.

7. The highly oriented polyolefin fiber according to claim 1, wherein the tensile strength of the at least one polyolefin fiber is at least 90 g/denier.

8. The highly oriented polyolefin fiber according to claim 1, wherein the tensile strength of the at least one polyolefin fiber is at least 100 g/denier.

9. The highly oriented polyolefin fiber according to claim 1, wherein the tensile strength of the at least one polyolefin fiber is at least 110 g/denier.

10. The highly oriented polyolefin fiber according to claim 1, wherein the modulus of tension of the at least one polyolefin fiber is at least 1600 g/denier.

11. The highly oriented polyolefin fiber according to claim 1, wherein the modulus of tension of the at least one polyolefin fiber is at least 1700 g/denier.

12. The highly oriented polyolefin fiber according to claim 1, wherein the modulus of tension of the at least one polyolefin fiber is at least 1800 g/denier.

13. The highly oriented polyolefin fiber according to claim 1, wherein the modulus of tension of the at least one polyolefin fiber is at least 1900 g/denier.

14. The highly oriented polyolefin fiber according to claim 1, wherein the modulus of tension of the at least one polyolefin fiber is at least 2000 g/denier.

15. The highly oriented polyolefin fiber according to claim 1, wherein the modulus of tension of the at least one polyolefin fiber is at least 2100 g/denier.

16. The highly oriented polyolefin fiber according to claim 1, wherein the modulus of tension of the at least one polyolefin fiber is at least 2200 g/denier.

17. The highly oriented polyolefin fiber according to claim 1, wherein an energy-to-break of the at least one polyolefin fiber is at least about 75 joules/gram.

18. The highly oriented polyolefin fiber according to claim 1, wherein an energy-to-break of the at least one polyolefin fiber is at least about 90 joules/gram.

19. The highly oriented polyolefin fiber according to claim 1, wherein an energy-to-break of the at least one polyolefin fiber is at least about 120 joules/gram.

20. The highly oriented polyolefin fiber according to claim 1, wherein an energy-to-break of the at least one polyolefin fiber is at least about 150 joules/gram.

21. The highly oriented polyolefin fiber according to claim 1, wherein an energy-to-break of the at least one polyolefin fiber is at least about 200 joules/gram.

22. The highly oriented polyolefin fiber according to claim 1, wherein the polyolefin is polyethylene.

23. An anti-ballistic article comprising highly oriented polyolefin fibers according to claim 1 embedded in a polymer.

24. The anti-ballistic article according to claim 23, wherein the highly oriented polyolefin fibers embedded in the polymer substantially transmits visible light.

25. A highly oriented polyolefin fiber comprising at least one polyolefin fiber with a tensile strength of at least 60 g/denier and having a non-axial stress induced defect density of less than 2000 per meter of the at least one polyolefin fiber.

26. The highly oriented polyolefin fiber according to claim 25, wherein the non-axial stress induced defect density is less than 1000 per meter of the at least one polyolefin fiber.

27. The highly oriented polyolefin fiber according to claim 25, wherein the non-axial stress induced defect density is less than 400 per meter of the at least one polyolefin fiber.

28. The highly oriented polyolefin fiber according to claim 25, wherein the non-axial stress induced defect density is less than 100 per meter of the at least one polyolefin fiber.

29. The highly oriented polyolefin fiber according to claim 25, wherein the tensile strength of the at least one polyolefin fiber is at least 65 g/denier.

30. The highly oriented polyolefin fiber according to claim 25, wherein the tensile strength of the at least one polyolefin fiber is at least 70 g/denier.

31. The highly oriented polyolefin fiber according to claim 25, wherein the tensile strength of the at least one polyolefin fiber is at least 75 g/denier.

32. The highly oriented polyolefin fiber according to claim 25, wherein a modulus of tension of the at least one polyolefin fiber is at least 1400 g/denier.

33. The highly oriented polyolefin fiber according to claim 25, wherein an energy-to-break of the at least one polyolefin fiber is at least about 75 joules/gram.

34. The highly oriented polyolefin fiber according to claim 25, wherein an energy-to-break of the at least one polyolefin fiber is at least about 90 joules/gram.

35. The highly oriented polyolefin fiber according to claim 25, wherein an energy-to-break of the at least one polyolefin fiber is at least about 120 joules/gram.

36. The highly oriented polyolefin fiber according to claim 25, wherein an energy-to-break of the at least one polyolefin fiber is at least about 150 joules/gram.

37. The highly oriented polyolefin fiber according to claim 25, wherein the polyolefin is polyethylene.

38. An anti-ballistic article comprising highly oriented polyolefin fibers according to claim 25 embedded in a polymer.

39. The anti-ballistic article according to claim 38, wherein the highly oriented polyolefin fibers embedded in the polymer substantially transmits visible light.

40. A polymer filament comprising:
a stretched polymer having a tenacity greater than 82 g/denier.

41. A method of making a drawn polyolefin fiber comprising:
gel-spinning gel-fiber from a polyolefin material and another material;
removing a substantial amount of the another material from the gel-fiber to form a xerogel; and
elongating the xerogel at an elevated temperature, to form a drawn fiber;
wherein the removing a substantial amount of the another material from the gel-fiber is at least partially performed such that only axial or substantially axial stresses are applied to the gel-fiber.

42. The method of claim 41, wherein the removing a substantial amount of the another material from the gel-fiber has an earlier portion and a later portion where the later portion has fewer non-axial stresses than the earlier portion.

43. The method of claim 42, wherein the elongating the xerogel is at least partially performed such that only axial or substantially axial stresses are applied to the xerogel.

44. The method of claim 43, wherein the elongating the xerogel has an earlier portion and a later portion where the earlier portion has fewer non-axial stresses than the later portion.

45. A method of making a drawn polyolefin fiber comprising:
gel-spinning gel-fiber from a polyolefin material and another material;
removing a substantial amount of the another material from the gel-fiber to form a xerogel; and
elongating the xerogel at an elevated temperature, to form a drawn fiber;
wherein the elongating the xerogel is at least partially performed such that only axial or substantially axial stresses are applied to the xerogel.

46. The method of claim 45, wherein the elongating the xerogel has an earlier portion and a later portion where the earlier portion has fewer non-axial stresses than the later portion.

47. A substantially transparent article including oriented polyolefin fibers comprising a plurality of polyolefin fibers with a tensile strength of at least 10 g/denier embedded in a transparent polymer,
wherein the transparent polymer is index matched to the plurality of polyolefin fibers; and
wherein each polyolefin fiber of the plurality of polyolefin fibers has a non-axial stress induced defect density of less than 2000 per meter.

48. The transparent article according to claim 47, wherein the tensile strength of the plurality of polyolefin fibers is at least 20 g/denier.

49. The transparent article according to claim 47, wherein the tensile strength of the plurality of polyolefin fibers is at least 30 g/denier.

50. The transparent article according to claim 47, wherein the tensile strength of the plurality of polyolefin fibers is at least 40 g/denier.

51. The transparent article according to claim 47, wherein the tensile strength of the plurality of polyolefin fibers is at least 50 g/denier.

52. The transparent article according to claim 47, wherein the non-axial stress induced defect density is less than 1000 per meter in each polyolefin fiber.

53. The transparent article according to claim 47, wherein the non-axial stress induced defect density is less than 400 per meter in each polyolefin fiber.

54. The transparent article according to claim 47, wherein the non-axial stress induced defect density is less than 100 per meter in each polyolefin fiber.

55. The transparent article according to claim 47, the transparent polymer is index matched to within 0.05 of the plurality of polyolefin fibers.

56. The transparent article according to claim 47, wherein the polyolefin fibers are polyethylene fibers.
